(19) United States
(12) Patent Application Publication
(10) Pub. No.: US 2012/0197677 A1
(43) Pub. Date: Aug. 2, 2012

(54) MULTI-ROLE BASED ASSIGNMENT

(75) Inventors: Anuradha Bhamidipaty, Bangalore (IN); Seema Prasanth Kumar, Bangalore (IN)

(73) Assignee: INTERNATIONAL BUSINESS MACHINES CORPORATION, Armonk, NY (US)

(21) Appl. No.: 13/016,125

(22) Filed: Jan. 28, 2011

(51) Int. Cl. G06Q 10/00

(52) U.S. Cl. 705/7.13

(57) ABSTRACT

A method and system to effectively apply the real time resource information into process models at design time. When process models are being prepared, an optimal list of candidate roles for each task within the process is presented. This list is generated dynamically based on the characteristics of the underlying resources within the roles. Further, the same information, along with historical data related to past performance at a resource level, can be leveraged during process simulations for optimal resource allocations.

### TECHNICAL FIELD

Embodiments of the invention relates generally to a system and method for assigning a role set to a task that denotes an indicative list of preferred roles to perform the task.

### BACKGROUND

Typically entities or conglomerations doing business receive many inputs, requests or orders that need to be properly processed by a number of individuals in order to accomplish the respective or end goal requested by the customer. In processing such customer's requests, the executives (including administrators, supervisors etc.) of the business entity typically review the same and select the individuals or departments that are best able to complete the goal, based on the workload as well as the skill or experience of the individuals or departments.

In order to facilitate the orderly processing of the workload of a business entity, various models have been developed to streamline the process and place into effect monitoring functions to allow the executives to track the workload and verify that tasks are not lost or forgotten, that the individuals are not overloaded, or that certain tasks are not assigned to a person who is not capable of handling the same, etc.

### BRIEF SUMMARY

Embodiments of the invention disclose a method, a system and a computer program product for augmenting resource allocation strategies with real time resource data in an entity. The notion of resource properties is employed, and based thereon, a resource allocation model is realized. This framework guides an executive in selecting the best choices for role and resource allocation. In accordance with the invention, dynamic resource allocation allows the specification of resource constraints based on resource information from multiple data sources, and in one embodiment provides algorithms for dynamic resource allocation based on resource constraints coupled with historical resource allocation data.

In accordance with an embodiment, disclosed is a method of allocating resources in/for a business entity. The method includes on receiving a task, assessing a repository to identify an optimal resource who can complete the task and allocating the task from completion to the resource identified, where the optimal resource is selected based on a set of pre-defined criteria or rules, and this is done preferably in real-time or in a batch process.

In accordance embodiment of the invention disclose a method of allocating resources for a business entity including receiving requirements of a task from an analyst, where the task requirements include a plurality of properties and each property is assigned a value; accessing an repository, wherein the repository is an updatable repository storing different roles available, and the updatable repository is updated to provide current properties of each role; and selecting a set of candidate roles from the database that satisfy the properties of the task. The embodiments further includes accessing the updateable repository to identify the set of candidate roles; and selecting from the updatable repository a resource from the set of candidate roles to complete the task.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description. The above as well as additional objectives, features, and advantages of the present invention will become apparent in the following detailed written description.

### BRIEF DESCRIPTION OF THE DRAWINGS

The description of the illustrative embodiments is to be read in conjunction with the accompanying drawings, wherein:

FIG. 1 is a block diagram of a data processing system adapted for carrying out the methods according to the invention;

FIG. 2 provides an exemplary block diagram representation of the tasks of a process, within which the invention is practiced, according to one embodiment;

FIG. 3 illustrates an exemplary diagram of a process in accordance with an embodiment; and

FIG. 4 is an exemplary diagram illustrating multi-role assignment capabilities according to an embodiment.

### DETAILED DESCRIPTION

The illustrative embodiments provide a method, system and computer program product for providing multi-role assignments in business process models.

In the following detailed description of exemplary embodiments of the invention, some specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined by the appended claims and equivalents thereof.

It is understood that the use of specific component, device and/or parameter names (such as those of the executing utility/logic described herein) are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized.

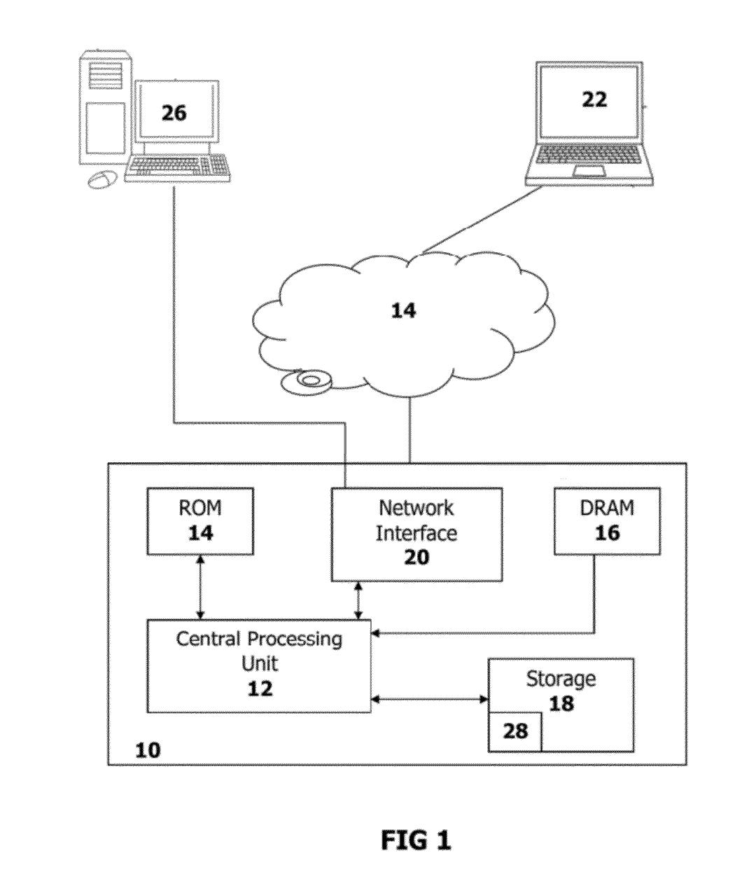

Reference is now made to the figures, and starting with FIG. 1, there is depicted an exemplary block diagram representation of an example data processing system (DPS), which can be utilized within one embodiment. The data processing system 10 comprises a a computing device which includes a central processing unit (CPU) 12, a read only memory 14, a dynamic random access memory 16, a hard disk drive 18, and other conventional components (not shown) as required to adapt the system 10 to the particular application. For example, few of the DPS cover a desktop computes, servers, laptop computers, mobile phones, personal digital assistants and the like. The application or software or module 28 in which the process is embodied can be stored on the hard disk drive 18. In a further embodiment, such a process may be embodiment in a storage medium and accessed over a wired or wireless network. Each memory unit 14, 16 and 18 can be connected in a conventional manner via one or more buses to the (CPU) 12. The data processing system 10 can also be a mainframe computer, server computer or other data processing system capable of carrying out the method described herein. In addition, the data processing system can be of the type identified below.

One or more office computers can be coupled by way of a network interface 20 to the data processing system 10 to submit projects thereto, receive assignment therefrom and generally communicate to carry out the goal desired from each project. Computers 22, for example, can be coupled via the Internet 24 to the data processing system 10. One or more local computers 26 can also be coupled to the data processing system 10 via a wired or wireless local network, or otherwise. The components of the data processing system 10 can be other than illustrated, such as a desk top computer in rudimentary applications. Indeed, any other computing system can be adapted for use with the methods of the invention.

Those of ordinary skill in the art will appreciate that the hardware components and basic configuration depicted in FIG. 1 may vary. The illustrative components within DPS 10 are not intended to be exhaustive, but rather are representative to highlight essential components that are utilized to implement embodiments of the invention. For example, other devices/components may be used in addition to or in place of the hardware depicted. The depicted example is not meant to imply architectural or other limitations with respect to the presently described embodiments and/or the general invention. In one embodiment the data processing system depicted in FIG. 1 may be, for example, an IBM eServer pSeries system, a product of International Business Machines Corporation in Armonk, N.Y., running the Advanced Interactive Executive (AIX) operating system or LINUX operating system.

As noted above, the software instructions adapted for carrying out the process 28 of the embodiment of the invention can be stored separately as a module in the data processing system 10, and particularly in the storage device such as the hard disk drive 18.

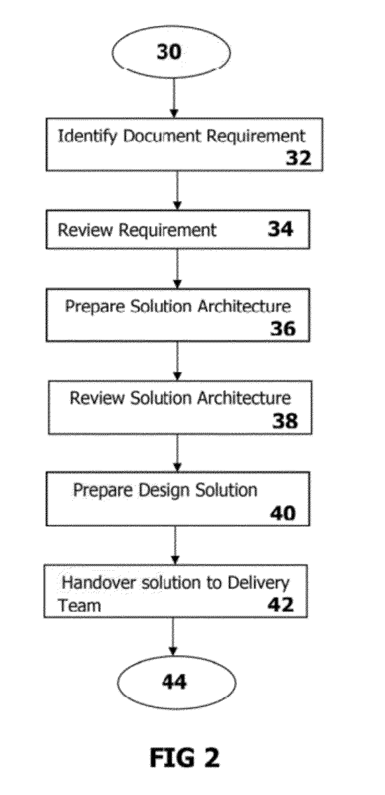

FIG. 2 illustrates an exemplary process including the various tasks in a particular business to be performed by an entity. This example process can be carried out in any organization, preferably that involving service delivery, which would contain the typical Service Delivery Lifecycle (SDLC) steps. Each of the tasks within the process would be assigned to appropriate roles in the organization/entity. The process starts at step 30 and at task block 32 the requirements are identified, for example the requirements can be in the form of document requirements. At task block 34 the requirements are reviewed, and at task block 36 the architecture based on the requirements is prepared, which can in one embodiment include solution architecture. Task block 38 illustrates the review process, where the solution architecture that is prepared is reviewed and at task block 40 a solution design is prepared based on the requirements that were provided. Task block 42 indicates that the solution is handed over to the delivery team. The end of the service delivery process is noted at 44.

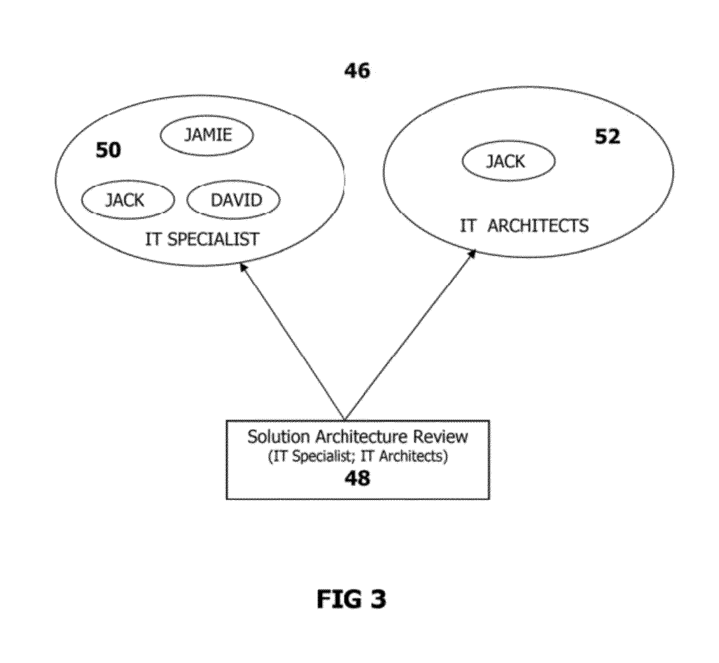

Reference is now made to FIG. 3, which illustrates an exemplary instance of multi-role assignment, described in more detail below. The task may be assigned to a resource from one of the roles, depending on the resource criteria (skill, experience, etc.) and availability. Here, during review 48, i.e., solution architecture review, an IT specialist 50 can be selected, or an IT architect 52, based on the resource criteria can be selected.

For this example, the task “Review Solution Architecture” is considered to be within the Service Delivery business process. Table 1 below summarizes the basic requirements for this task to be executed.

TABLE 1

| Property | Value |
|---|---|
| Minimum Skills | J2EE—Level 4 |
| | Architecture—Level 2 |
| Skills (optional) | Telecom—Level 2 |
| Min Experience (optional) | 8 years |
| Duration | 3 days (7 hr work days) |
| Cost/Budget | 1800 USD |

The requirements illustrated in Table 1 identify the minimum skill and experience levels for the task “Review Solution Architecture” to be completed successfully. It also specifies the duration for this task and the cost/budget constraints. Table 2 below summarizes the different kinds of roles available in the organization to perform the various tasks, along with their skill and experience levels.

TABLE 2

| | Billable Rate | | Skill level | Experience |
|---|---|---|---|---|
| Role Name | (in USD) | Skill | (min required) | (min years) |
| IT Architect | 80 | J2EE | 4 | 8 |
| | | Architecture | 3 | |
| IT Specialist | 70 | J2EE | 4 | 6 |
| | | Architecture | 2 | |
| | | Debugging | 3 | |
| Programmer | 60 | Java | 4 | 3 |
| | | J2EE | 4 | |
| | | Debugging | 3 | |

According to embodiments of the invention the parameter of role assignment is considered for the process to be executed. The selection of the correct set of roles to be assigned to a given task is considered by the executive, for example a business analyst, at the time of modeling the process. Described herein is an approach for selecting the correct set of roles based on the properties of the role. A set of selection rules is used to identify the correct set of roles.

The selection rules for choosing the set of candidate roles are set forth below.

Selection Rule 1: Choose the role(s) that possess at least Level 4 J2EE skills and Level 2 Architecture skills.

Selection Rule 2: Choose the role(s) where Total Cost is less than 1800 USD.

Based on the above selection rules, the following roles are seen to be ideal to perform the task “Review Solution Architecture”: IT Architect or IT Specialist. Therefore, based on the above suggestions derived by applying the selection rules, the business analyst can assign the role set {IT Architect, IT Specialist} to the task “Review Solution Architecture” in the process.

Resource assignments are considered during the process, as described below. The modeled process can be simulated to analyze process behavior and identify areas of improvement. The simulation engine will choose an appropriate resource from one of the assigned roles to perform the task.

As a first example scenario, the available resources in the organization for each of the roles, and their associated properties, are listed in the Table 3 below.

TABLE 3

| Resource | | | Skill | |
|---|---|---|---|---|
| Name | Role Name | Skill | level | Experience |
| ITA1 | IT Architect | J2EE | 5 | 10 |
| | | Architecture | 4 | |
| ITA2 | IT Architect | J2EE | 4 | 8 |
| | | Architecture | 2 | |
| ITS1 | IT Specialist | J2EE | 4 | 5 |
| | | Architecture | 2 | |
| | | Troubleshooting | 3 | |
| ITS2 | IT Specialist | J2EE | 4 | 8 |
| | | Architecture | 2 | |
| | | Troubleshooting | 3 | |

The selection rules for selecting the ideal resource to perform the task within a given process instance will be based on the properties of the respective resources. Set forth below are the selection rules (in order of preference) for choosing the correct resource:
Selection Rule 1: Choose the resource which possesses Level 2 skills in Telecom.
Selection Rule 2: Choose the resource with the lesser Total Cost.
Selection Rule 3: Choose the resource with highest level of Experience.

Since there are no existing resources that meet the optional skill requirement, the executives choice would be based on the resources that would incur the least Total Cost. Hence, the initial set of resource choices would be {ITS1, ITS2}. Out of this set, since the resource ITS2 is more experienced, the ideal choice in this scenario would be ITS2.

A second scenario is illustrated using the same parameters as in the first scenario, but where the resource ITA2 has an upgraded skill profile, based on recent education/experience. In the illustration of Table 4 below, the resource ITA2 has acquired Telecom domain expertise at a skill level of 2.

TABLE 4

| Resource | | | Skill | |
|---|---|---|---|---|
| Name | Role Name | Skill | level | Experience |
| ITA1 | IT Architect | J2EE | 3 | 10 |
| | | Architecture | 4 | |
| ITA2 | IT Architect | J2EE | 4 | 8 |
| | | Architecture | 2 | |
| | | Telecom | 2 | |
| ITS1 | IT Specialist | J2EE | 4 | 5 |
| | | Architecture | 1 | |
| | | Troubleshooting | 3 | |
| ITS2 | IT Specialist | J2EE | 4 | 8 |
| | | Architecture | 2 | |
| | | Troubleshooting | 3 | |

Since the selection rules specify precedence on the availability of optional skill in Telecom, over the total cost of the resource and experience criteria, the new choice for the ideal resource would be ITA2 to execute the task.

The historical data of resource to task allocations of real-time processes can also be leveraged by the process simulation engine. The historical data will particularly be significant when the executive wishes to do a “what-if” analysis based on varied assignments.

For the same example scenario it is assumed that the historical data indicates that in the past the “Review Solution Architecture” task has normally been assigned only to resources from the IT Architect role. The executive may want to compare the simulation results of the two different options:

Option 1—Task assigned to the role set {IT Architect, IT Specialist}; and

Option 2—task assigned to the role IT Architect.

During the simulation, the real-time resource data that includes the current values of the resource properties will be utilized to achieve ideal combinations of resource allocation. When multiple process instances are involved, resource availability also becomes a factor for selection. In case of availability conflicts, the resource selection rules can be applied in order of preference, to ensure minimum wait time for resource allocation. For example, assume that at a given point of time there are two parallel instances of the process running.

Option 1: Based on the resource properties listed in Table 4 for the second scenario, the resource selected for the first process instance would be ITA2 (Telecom Skills). For the next instance that is running in parallel, the resource selected would be ITS2 (Lesser cost), since ITA2 is no longer available for allocation.

According to Option 2, since this only provides resources to be allocated from the IT Architect role, the available resources within this role will be chosen based on the selection preference. The first instance will be assigned ITA2 (Telecom skills) and the second instance would be assigned ITA1.

Currently, none of the existing simulation approaches is able to leverage the joint benefits of the historical data as well as the real time resource property information to come up with the optimal set of resources to be allocated to process instances. The simulation result comparison across the two options will provide the analyst with valuable insights on the potential benefits in terms of either cost savings or better processing duration of one option over the other. Based on business needs, an informed decision can be made for choosing one option over the other.

The understanding of resource allocation in process involves various terms and terminology. Set forth below are basic definitions, in order to understand the various constructs being referred to in relation to a business process model.

Task: A task refers to a unit of work or specific activity that must be performed by a resource within the context of a process.

Indicative Set: An indicative set refers to a set of roles that could be possible candidates to perform the task. An indicative set is essentially a list of suggested roles that are capable of performing the task.

Resource: A resource s represents an individual or business department performing a single unit of work. The resource can be either a human resource or a system resource. One or more roles can be performed by a resource. The parameters of a resource are the role(s) to which the resource belongs, and the set of resource properties that define the individual characteristics of the resource.

Resource Property: A resource property p describes an attribute value pair that is used to describe and distinguish role or resource characteristics. Examples of resource properties are:

Skill represents the minimum required skill level for the resource or role.

Skill level is a qualifying parameter for the skill property. Typically skill levels can be categorized as level 1 to level 4, where level 1 is a beginner and level 4 is an expert.

Experience describes the number of years of work experience.

The specification of properties is dependent on the resource information that is captured in the organization in its various data sources. Ideally, any attribute of a resource in a data source is a potential resource property.

Resources can satisfy multiple resource properties, the mapping of which is captured by the function satisfy(p,s). The applicability of a resource property for a resource is represented by applicable(p,s). For a resource, the applicability of a property is valid for those properties which are not already applicable at the role level. A resource property can be declared optional for the resource allocation criteria, which is denoted by optional(p).

Role: A role r represents an abstract grouping of resources. Roles generally correspond to designations or employee levels within the organization hierarchy. The role description is considered to be a set of resource properties that are common across the members belonging to the role. Individual members within the role may have varied values for the same property.

In the model described herein, as an exemplary embodiment four properties are used to describe a role, namely, cost, skill, skill level and experience. When a role satisfies a resource property p and a resource s belongs to a role r, satisfy(p,s) is true.

r=role(s) && satisfy(p,r)→satisfy(p,s)
applicable(p,r) denotes if a resource property is applicable to a role.

A process may be represented graphically as: G=(N, E, Start, End), where: N is the set of nodes. Each node can be either a work node or a decision node. A work node actually performs a task T, whereas a decision node only calculates the value of a boolean condition.

Start is the start node of the process. End is the end node of the process. E=(Ni, Nj) is a set of directed edges, each edge being of the form Ni-Nj. Edges are of two types: forward edges, where Nj is executed after Ni in the process; and backward edges, which represent repeated executions in a loop. For any edge (Ni, Nj), Nj is the direct successor of Ni. If Nj is reachable from Ni via more than one edge, then Nj is an indirect successor of Ni. Similarly, Ni is the direct or indirect predecessor of Nj, respectively.

It is assumed that every node in the process is reachable from the start node, and the end node is reachable from any other node in the business process. For purposes of simplicity, the example described herein illustrates the assignment of a resource to a single task in the process model and the same can be applied to all tasks in any process model.

The resource allocation constructs are next described. Introduced are the following two resource allocation constructs that are available for an executive during the process design phase to express resource allocation requirements.

The first resource property set allocation construct is described. In this construct, the business analyst/executive specifies an ordered list of resource properties that need to be satisfied for allocating a role and resource to a particular task. Some of the properties could be optional. Therefore, the input is a set P of resource properties, where

P={p1, p2 . . . pₙ} and optional(pᵢ)=true or false.

The ordering of the parameters p1 . . . pn means that satisfying p1 is more important than satisfying p2, and so on.

The role and resource property set allocation construct is described next. This construct enables the business analyst/executive to specify an indicative set of preferred roles to perform a task. In addition, the analyst also specifies the ordered list of resource properties which form the resource selection criteria based on which the role and resource for assignment for that task is chosen. The resource allocation strategy aids the business analyst in suggesting the role(s) and resource(s) that satisfy the resource properties within the indicative roles. The input here is a set R of indicative roles and a set P of resource properties:

R={r1, r2 . . . rₙ} and P={p1, p2 . . . pₘ} and optional(pᵢ)=true or false

The resource allocation strategy can be summarized by the following sequence of steps:

(1) Perform role selection for identifying the set of roles that satisfy the resource properties specified by the business analyst. If there are no role(s) that satisfy all resource properties, identify the next best set of roles. The ordering of roles is based on the ordering of the properties, meaning, the first ‘next best role set’ is the one with roles that satisfy all resource properties except the last in the ordered list of resource properties.

(2) Perform resource selection for identifying the set of resources that belong to the roles and satisfy the resource properties which are applicable at the resource level. If there are no resource(s) that satisfy all resource properties, identify the set of next best set of resources. If the resource selection identifies multiple resources, choose the one with the least cost.

(3) For a scenario with multiple processes executing at the same time or when there are concurrent and multiple instances of a process, the business analyst can perform simulation to identify the best match of role and resource combination for each process instance. With real time resource data available, the simulation engine can model current values of resource properties to determine the optimal resource allocation. Additionally, the simulation engine can also model concurrent execution of multiple business processes or multiple instances of the same process.

(4) As the resource data captured in the various data sources are updated, triggers can be configured to re-run the resource allocation strategy for again determining the optimal selection.

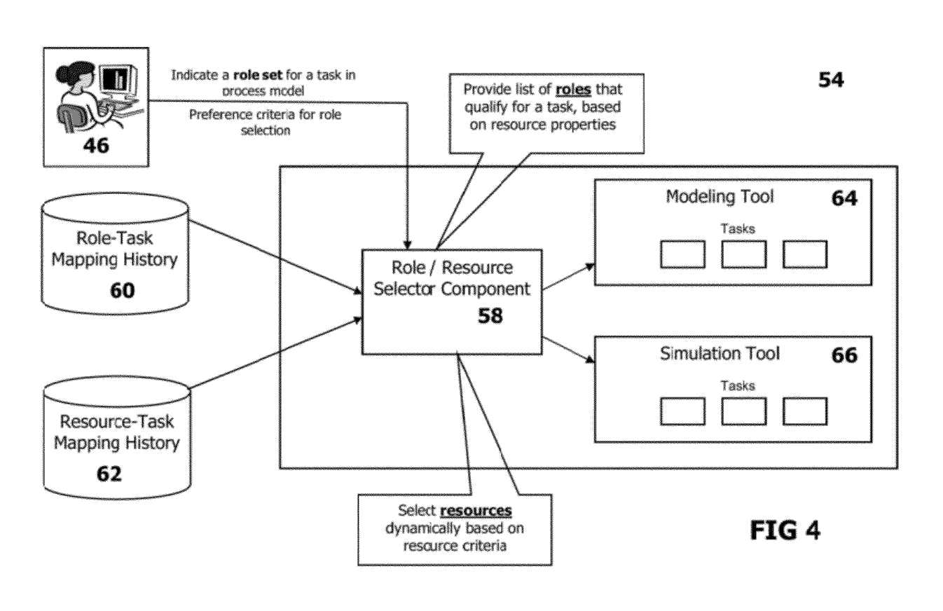

FIG. 4 illustrates an exemplary system 54 according to one of many possible embodiments adapted for modeling the process. Here, the user 56 is provided with the capability to indicate a set of roles suitable for the process being modeled. Moreover, the user has the capability to provide preference criteria to select a suitable resource from the given set of resources. These parameters are entered into a role/resource selector component 58 of the system 54. The role/resource selector component 58 can select from a role-task mapping history 60 and from a resource-task mapping history 62. During the modeling, the role/resource selector component 58 provides to the modeling tool 64 (of conventional construction) the set of roles that qualify for a given task. This role set is arrived at by considering the preference criteria specified and selecting all the roles that satisfy the criteria. In addition, during the business process simulation, the role/resource selector component 58 dynamically selects the best resource suitable to perform the project, from within the role set, and provides the same to the simulation tool 66.

In accordance embodiments of the invention, described below are the methodologies/techniques that implement the steps described in the foregoing resource allocation strategy. The role and resource selection strategy according to an embodiment is shown in Algorithm 1 below. The first step of the algorithm invokes the roleSelection function. In this function, roles which satisfy the mandatory resource properties are selected. If no role satisfies all resource properties, the next best role set is selected. The second step invokes resourceSelection to select the resources based on the roles selected in step 1. The resources which belong to the selected roles and which satisfy all the other applicable resource properties are placed on a shortlist. If no resource satisfies all resource properties, the next best resource set is selected. The selected role and resource sets are returned to the business analyst. The identified role and resources can be used as input for simulation to identify the best suitable resource.

Algorithm 1

Input: A set P of resource properties
Output: Role and resource assignment that match the specified properties
Step 1: roleSet = roleSelection(P)

| | |
|---|---|
| a) | roleSet = φ |
| b) | foreach pᵢ in P, |

| do | |
|---|---|
| a. | roleSetᵢ = 0 |
| b. | for each role rⱼ, do |

| | |
|---|---|
| i. | if applicable(pᵢ,rⱼ) and satisfy (pᵢ,rⱼ) and |

op-

tional(pᵢ) = false then roleSetᵢ = roleSetᵢ ∪

rⱼ

| | |
|---|---|
| c. | end for |

| c) | end for |
|---|---|
| d) | roleSet = intersection(rolesSetᵢ ∀i) |
| e) | while roleSet = φ, roleSet = partialIntersection(rolesSetᵢ ∀i) |
| | Step 2: resourceSet = |
| resourceSelection(roleSet,P) | |
| a) | resourceSet = φ |
| b) | foreach Pᵢ in P and rⱼ in roleSet do |

| | |
|---|---|
| a. | foreach sₖ such that rⱼ = role(sₖ) do |

| | |
|---|---|
| i. | if applicable(pi,sk) and satisfy(pᵢ,sₖ) then |
| | resourceSetᵢ = resourceSetᵢ ∪ |

sₖ

| | |
|---|---|
| b. | end for |

| | |
|---|---|
| c) | end for |
| d) | resourceSet = intersection(resourceSetᵢ ∀i) |
| e) | while resourceSet = φ, resourceSet = |

partialIntersec- tion(resourceSetᵢ ∀i)

Step 3: return

resourceSet

Historical data based resource allocation is shown in Algorithm 2. The first step identifies the roles that were previously allocated to execute the task. The second step invokes resourceSelection to select the resources based on roles identified in step 1. The selected role and resource set are returned to the business analyst.

Algorithm 2

Input: A set P of resource properties
Output: Role and resource assignment that match the specified

| | |
|---|---|
| properties and use | historical data |

Step1: roleSet = roleSelectionFromHistory(T) // for a task T, identify

| | |
|---|---|
| the set of roles | that were earlier assigned to execute T |

Step2: resourceSet = resourceSelection(roleSet, P)
Step3: return resourceSet

Dynamic resource selection is shown in Algorithm 3 below. Triggers are created on the resource data sources which are triggered when changes to the data occur. Once triggered, the role and resource selection strategy is re-invoked to accommodate the changes.

Algorithm 3

Input: Changes to resource data sources
Output: Role and resource assignment that match the required

| resource properties, | taking into account the dynamic changes to |
|---|---|
| | resource data |

Step1: Create triggers on changes to resource data
Step2: if trigger is activated then do roleSet = roleSelection(P)
Step2: resourceSet = resourceSelection(roleSet, P)
Step3: return resourceSet

From the foregoing, it can be appreciated that the potential benefits of real time resource information being made available to the process models at design time has not been described in detail. In contrast with the prior art, the approach described herein has the following key benefits, in addition to others not enumerated:
1. Assist the business analyst through the process of modeling by providing suggestions on role assignment, and also provide an option to choose multiple candidate roles or role sets to be assigned to a given task in the process.
2. Role assignment suggestions are derived based on the properties of the underlying resources, as well as information available in historical repositories. The real-time resource properties can be evaluated as opposed to static data.
3. Provide the ability to analyze resource utilization behavior based on real time resource information.

In each of the process flows described above, one or more of the methods may be embodied in a computer readable medium containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of present invention. Use of a particular sequence is therefore, not to be taken in a limiting sense, and the scope of the present invention is defined only by the appended claims.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, R.F, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to process flow illustrations, descriptions and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the process flow descriptions and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
accessing a repository to identify roles and resources, wherein the roles of the resources are mapped;
identifying a set of optimal resource, wherein the set of optimal resource can complete a task; and
allocating the task for completion to the optimal resource.

2. The method as claimed in claim 1, further comprises
receiving a tasks, wherein the task includes a set of requirements to be completed by the entity.

3. The method as claimed in claim 1, wherein the optimal resource is selected using at least one of a set of pre-defined criteria, and selecting the set of roles based on a set of pre-defined criteria.

4. The method as claimed in claim 1, wherein the repository comprises the roles and the resource includes at least one of a structure or unstructured data.

5. The method as claimed in claim 1, on receiving the task further comprises
updating the task in the repository; and
storing in the repository current parameters of each role and resource available against the task.

6. The method as claimed in claim 4, further comprises updating the repository in real time or in a batch to provide current updated parameters of the roles and resources.

7. The method as claimed in claim 3, further comprises assigning a priority to the at least one of the set of pre-define criteria, and higher priority criteria have priority of selection over lower priority criteria.

8. The method as claimed in claim 1 further includes selecting a higher priority criteria when a plurality of criteria are satisfied, the criteria includes properties associated with the resource, and are assigned a preference

9. The method as claimed in claim 1, further comprising dynamically allocating resources based on resource constraints coupled with historical resource allocation data, wherein the repository includes historical data.

10. The method as claimed in claim 10, further comprising flagging a resource as being busy and unavailable for selection for another task to be completed.

11. The method as claimed in claim 1, further comprising responding to a trigger to rerun a resource allocation strategy, where the trigger indicated that the database has been updated.

12. The method as claimed in claim 1, further comprising;
1) carrying out a role selection function by selecting roles satisfying mandatory resource properties;
2) on negative determination of the resource properties in step 1), selecting a next best role available;
3) carrying out a resource selection function to select resources based on roles selected in steps 1) or 2);
4) identify the resources belonging to the selected roles and satisfying applicable resource properties; and
5) on negative determination of resource satisfies all resource properties, select a next best resource set.

13. The method as claimed in claim 1, further comprising;
1) receiving a plurality of roles associated with the tasks;
2) selecting role from the plurality of roles specified in Step 1) satisfying other pre-defined criteria;
3) selecting resources based on roles selected in Step 2) and satisfying applicable resource properties; and
4) validating the assignment of the role and resource to the task, before allocating the task to the resource.
